(19) United States
(12) Patent Application Publication
(10) Pub. No.: US 2025/0122678 A1
(43) Pub. Date: Apr. 17, 2025

(54) DRIVE FOR A BARRIER SYSTEM

(71) Applicant: BelFox Torautomatik GmbH, Kalbach (DE)

(72) Inventors: Rrezarta BEQIRAJ, Neuhof Kr Fulda (DE); Matthias ROMMEL, Ebersburg (DE); Jens Broßmann, Neuhof Kr Fulda (DE)

(73) Assignee: BelFox Torautomatik GmbH, Kalbach (DE)

(21) Appl. No.: 18/904,868

(22) Filed: Oct. 2, 2024

(30) Foreign Application Priority Data
Oct. 13, 2023 (DE) 102023128030.9

(51) Int. Cl. E01F 15/12

(52) U.S. Cl. CPC E01F 15/12

(57) ABSTRACT

A drive unit (10) for a foldable safety barrier boom (100) having a drive motor (12), in particular a drive motor (12) with a brake; a threaded spindle (16) which is coupled with the drive motor (12) such that the rotational movement of the output of the drive motor (12) is transmitted to the threaded spindle (16), and which is coupled with a spindle nut (18), such that it linearly moves along a slide guide (21) arranged in parallel to the threaded spindle (16) upon rotation of the threaded spindle (16); a slide (20) which is fixedly coupled with the spindle nut (18); and a coupling joint (27), in particular in the form of a coupling rod (27), which is jointly provided at the slide (20) for jointly coupling the slide (20) to a barrier arm (110) of the safety barrier boom (100).

### BACKGROUND OF THE INVENTION

### 1. Field of the Invention

The invention refers to a drive unit for a barrier system, in particular to a drive unit for a foldable safety barrier boom, and to a safety barrier boom comprising such drive unit.

### 2. Description of the Related Art

Work areas, loading ramps for commercial vehicles, etc. in industrial environments are secured using ramming protection products and safety barriers, for avoiding dangerous situations for workers and employees, like crashes (falling), unintentional intrusion into driveways of warehouse vehicles etc. Such safety barriers are made of flexible plastic in the form of bollards, gates, etc. and withstand mechanical loads, like e.g. collisions with forklifts, in a large extent without being damaged.

In this context, there are safety barriers, which can be folded away or rotated away, for allowing the passage into a work area as needed. This means, such safety barriers are formed as a gate system which can be opened and closed, although they still have the properties of general safety barriers, as the capacity to bear mechanical loads. Opening and closing of such gate systems is carried out manually, i.e. the barrier is manually lifted or moved down or rotated, for opening or closing a passage.

This results in disruptions of the workflow for manually opening and closing the barrier system or barrier boom.

CN 1 12 081 033 A discloses a drive for a gate, in particular a swing gate, which comprises a drive motor and a threaded spindle. The threaded spindle is coupled with the drive motor such that the rotational movement of the output of the drive motor is transmitted to the threaded spindle and is further coupled with a spindle nut such that the spindle nut linearly moves along a slide guide upon rotation of the threaded spindle. A slide is provided which is fixedly coupled with the spindle nut. A coupling joint is jointly coupled to the slide for jointly coupling the slide to a barrier arm of the swing gate. A coupling may be provided between the threaded spindle and the drive motor.

DE 195 17 592 A1 describes a ball screw drive for pivoting a barrier boom.

A drive unit for a boarding device (entry/exit) for a public transport vehicle is known from DE 20 2008 011 200 U1. The disclosed drive is not self-locking, such that an additional locking device for the drive is needed which causes a mechanical locking of the drive in a condition in which the drive is not energized. This additional brake is a mechanical brake and can be unlocked manually.

### SUMMARY OF THE INVENTION

Based on the foregoing, it is an object of the invention to provide a safety barrier in the form of an automated or motor-driven barrier system and a drive unit for such barrier system.

### Technical Solution

This object is solved with a drive unit comprising the features of claim 1. Preferred embodiments are defined in the dependent claims.

Accordingly, a drive unit for a foldable safety barrier boom comprises a drive motor, a threaded spindle which is coupled with the drive motor such that the rotational movement of the output of the drive motor is transmitted to the threaded spindle, and which is coupled with a spindle nut, such that it linearly moves along the threaded spindle or a slide guide arranged in parallel to the threaded spindle upon rotation of the threaded spindle, a slide which is fixedly coupled with the spindle nut, and a coupling joint, in particular in the form of a coupling rod, which is jointly coupled with the slide for jointly coupling the slide to a barrier arm of the safety barrier boom. This setting allows for a compact and sturdy drive unit, which can be disposed in a safety barrier, e.g. in a barrier boom made of sturdy plastics, and which can be driven in a fully automated manner at the same time. This makes it possible to open and close a barrier boom by means of a motor, and, thus, to render workflows more efficient.

Preferably, the drive unit further comprises a shaft coupling which is provided between the drive motor and the threaded spindle for transmitting the rotational movement of the output of the drive motor to the threaded spindle. This allows that coupling between the drive motor and the threaded spindle is stable on the one hand, i.e. the rotational movement of the output of the motor can be transmitted in a stable manner to the threaded spindle, a sturdy and simple coupling can be provided and, at the same time, if desired, a certain axial and/or radial clearance can be provided and tolerances can be compensated for, respectively.

The compact and sturdy construction of the drive unit is further enhanced if the drive motor is preferably a planet gear motor which allows to provide the required torque and has a compact construction. The planet gear motor preferably has a brake which makes it possible to fix the barrier position.

Preferably, the coupling joint is a coupling rod, i.e. an articulated rod at both ends, which shifts the point of application of force in the direction and against the direction of action of the force, namely from the slide into the barrier arm and vice versa. This allows to provide a sturdy and compact coupling and force transmission between slide and barrier arm.

Since opening of the barrier boom usually requires overcoming the gravity and, on the other hand, gravity usually supports closing the barrier boom, it is advantageous that the drive unit comprises a spring element or a spring assembly, which biases the slide in the direction of supporting the opening movement of the barrier boom. If, e.g. a movement vertically downwards results in an opening of the barrier boom by rotating and folding in the direction vertically upwards, the spring element or the spring assembly is provided such that is draws the slide vertically downwards. Such spring element or spring assembly is, for example, a pack of tension springs, preferably helical tension springs. For example, two or more helical tension springs can be provided as a pack, which are arranged symmetrically, and which bias the slide in a direction which corresponds to the opening direction of the barrier boom. This results in the force which has to be applied by the motor for opening or closing the barrier boom being more balanced.

The drive unit further comprises an emergency release with which the barrier can be manually operated in case of power failure, defects or safety requirements. For this purpose, the drive motor is provided with a brake with manual ventilation. The brake is ventilated when the emergency release is manually operated and the rotation of the motor is enabled. Because the threaded spindle is not self-locking, the barrier boom can be manually moved.

A safety barrier boom with a drive unit preferably comprises a bollard and the drive unit is provided in the bollard. Accordingly, it is not necessary to move the drive unit together with the barrier boom and the drive unit can be accommodated in a compact and space-saving manner in the bollard of the safety barrier boom.

In a preferred embodiment the safety barrier boom comprises a barrier arm which is jointly coupled with the coupling joint or the coupling of the drive unit. Alternatively, the safety barrier boom preferably comprises a first and a second barrier arm, wherein the first barrier arm is jointly coupled with the coupling joint or the coupling rod, respectively, and the second barrier arm is jointly connected to the bollard. The first and the second barrier arm are coupled to each other at their end distal from the bollard by means of a connecting element. This results in that a good safety barrier to falling or the like can be provided in different heights, and that, at the same time, a single drive unit is sufficient for opening and closing the safety barrier boom by means of rotation and folding, because of the connection of the two barrier arms and their lightweight construction.

The following are further aspects of the present invention:
1. A drive unit for a foldable safety barrier boom comprising
   a drive motor;
   a threaded spindle which is coupled with the drive motor such that the rotational movement of the output of the drive motor is transmitted to the threaded spindle, and which is coupled with a spindle nut, such that it linearly moves along a slide guide arranged in parallel to the threaded spindle upon rotation of the threaded spindle;
   a slide which is fixedly coupled with the spindle nut;
   and a coupling joint, in particular in the form of a coupling rod, which is jointly provided at the slide for jointly coupling the slide to a barrier arm of the safety barrier boom.
2. Drive unit according to aspect 1, further comprising a shaft coupling which is provided between the drive motor and the threaded spindle for transmitting the rotational movement of the output of the drive motor to the threaded spindle.
3. Drive unit according to one of the preceding aspects, wherein the drive motor is a planetary gear motor.
4. Drive unit according to aspect 3, wherein the drive motor is a planetary gear motor with a brake.
5. Drive unit according to one of the preceding aspects, wherein the coupling joint is a coupling rod.
6. Drive unit according to one of the preceding aspects, further comprising a spring element which biases the slide in a direction for supporting opening of the safety barrier boom.
7. Drive unit according to aspect 6, wherein the spring element is a pack of biased helical tension springs.
8. Drive unit according to one of the preceding aspects, further comprising an emergency release.
9. Drive unit according to aspect 8, wherein the emergency release comprises a manual ventilation, a push rod and a release device, wherein the manual ventilation is coupled with the release device by means of the push rod, and wherein a rotation of the drive motor is initiated upon a movement at the release device.
10. Safety barrier boom with a drive unit according to one of the preceding aspects.
11. Safety barrier boom according to aspect 10, comprising a bollard, wherein the drive unit is provided in the bollard.
12. Safety barrier boom according to aspect 10 or 11 having a first barrier arm, wherein the first barrier arm is jointly coupled to the coupling joint of the drive unit.

Safety barrier boom according to aspect 11 with a first and a second barrier arm, wherein the first barrier arm is jointly coupled to the coupling joint of the drive unit and the second barrier arm is jointly coupled to the bollard, and wherein the first and the second barrier arm are connected by means of a connecting element at their end distal with respect to the bollard.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following the invention is described by way of example based on the attached figures, in which:

FIG. 1 shows a safety boom according to the invention in perspective view;

FIG. 2 shows a perspective, partially cut view of an embodiment of the drive unit of the barrier boom; and

FIG. 3 is a perspective detail view of the drive unit, including spring packs, of FIG. 2.

### DETAILED DESCRIPTION OF THE PRESENTLY PREFERRED EMBODIMENTS

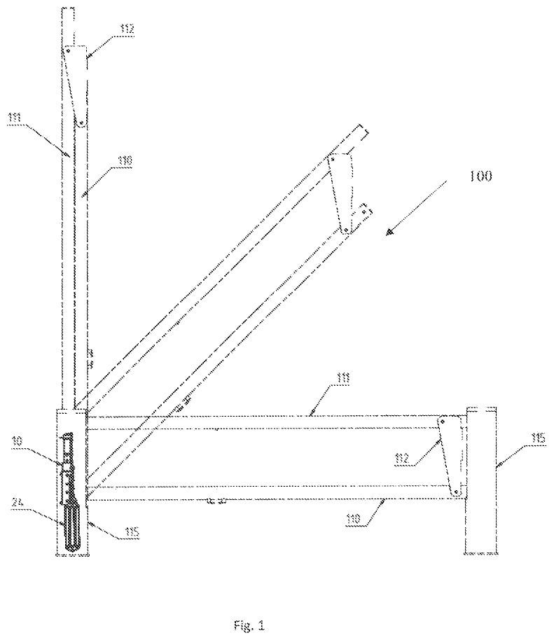

FIG. 1 shows by way of example a safety barrier boom 100 according to the invention, wherein two bollards 115 are shown. Two pairs of barrier arms 110, 111 are provided at one of the bollards 115. One of the barrier arms 111 is jointly, i.e. relatively rotatably, connected to the bollard 115. The other one of the barrier arms 110 is rotatably connected to a drive unit 10 which is accommodated in the bollard 115 and mounted there fixedly with respect to its position and orientation, such that the barrier arm 110 is also pivotable with respect to the bollard 115 between an open position of the safety barrier boom 100 and a closed position of the safety barrier boom 100.

The bollard 115 stands on the floor and extends substantially vertically and the barrier arms 110, 111 extend from this bollard 115 spaced to each other in substantially horizontal direction, when the safety barrier boom 100 is closed. This closed position of the safety barrier boom 100 is shown in FIG. 1 with the barrier arms 110, 111 extending to the right in FIG. 1 from the bollard 115. At their ends distal or away from the bollard 115, the barrier arms 110, 111 are connected with a common connecting member 112 in a joint manner, i.e. rotatable with respect to the connecting member 112. In the open position of the safety barrier boom 100 the two barrier arms 110, 111 extend substantially vertically upwards, in extension of the bollard 115, as it is also shown in FIG. 1. This means the barrier arms 110, 111 are rotated or pivoted around their joints at the bollard 115 or the drive unit 10 in the bollard 115, respectively, and are brought from their horizontal closed position into an open, substantially vertical position for opening the safety barrier boom 100. For this purpose the bollard 115 is provided in the region of the drive unit and up to its upper end with corresponding openings in its substantially cylindrical shape, i.e. with openings in the lateral surface of the circular cylinder and the upper end face, or is provided in this area as a cylinder half having a semicircle as a base are, corresponding to the upper end face.

A common bollard 115 can accommodate the drive units 10 for two or more barrier arm groups having barrier arms 110, 111; alternatively, each drive unit 10 might be accommodated in a separate bollard 115. In addition, the ends of the barrier arms 110, 111 distal to the drive unit 10 can be flush to a neighboring bollard 115 and, if desired, guided therein, in the closed position of the barrier boom 100, or might be provided as a free end. Any number of barrier arms 110, 111 can form a barrier arm group, respectively; apart of the two barrier arms 110, 111 shown in the figures forming a barrier arm group, one single barrier arm or three or more barrier arms which are substantially parallel to each other might form a group of barrier arms.

The safety barrier boom 100 as shown in FIG. 1 serves as impact protection or safety barriers, to secure work areas and loading ramps for trucks with the aid of flexible plastic doors. Therefore, safety barrier booms as described and shown here are made of flexible plastics which can withstand mechanical impacts and loads, as, e.g., collisions with fork lifts. At the same time such safety barriers are formed in a space-saving manner, for reducing and minimizing the space they take on work areas, loading areas or storage areas. Correspondingly, the drive unit 10, as described in the following with respect to FIG. 1 to FIG. 3, has to be compact on the one hand, such that it can be accommodated in a bollard 115 of such safety barrier boom 100, and has to be sturdy on the other hand, with respect to at least slight vibrations etc., such that it does not fail because of impacts etc. occurring in operation because of, e.g., collisions of fork lifts with the barrier boom.

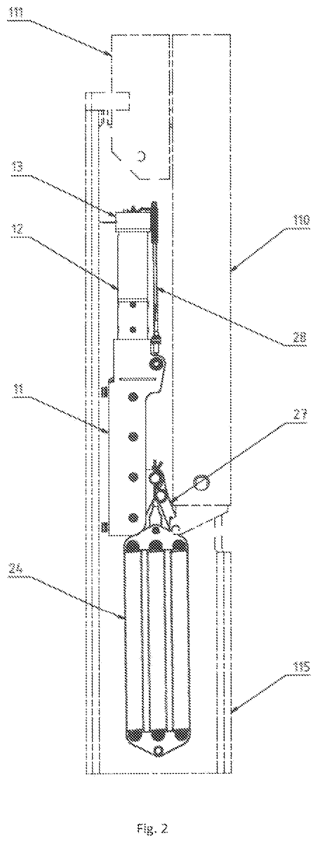

As shown in FIG. 2, a housing 11 of the drive unit 10 is, accordingly, provided in an upper part of a bollard 115, which is not completely closed around its circumference, and which is open to the top. The housing 11 is fixedly connected with the bollard 115 and accommodates the components of the drive unit 10. The housing 11 may be made of a light metal for additionally protecting the drive unit 10 against mechanical loads.

One of the two barrier arms 111 of the safety barrier boon is jointly, i.e. rotatably connected to the housing 11 at the upper end. Alternatively, this barrier arm could also be directly and jointly connected to the safety bollard 115, which is usually formed of plastics.

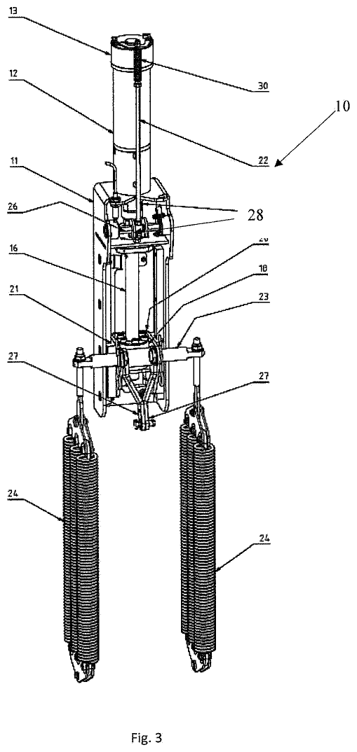

In the housing 11 there are provided a drive motor 12 for the drive unit 10, wherein the drive motor 12 is formed as a planetary gear motor 12 with a brake 13, a threaded spindle 16, a spindle nut 18 running on the threaded spindle 16 and a slide 20. A coupling rod 27 is further jointly provided on the slide 20 as a coupling joint coupling to the second barrier arm 110. The planetary gear motor 12 can be formed as a relatively long and, thus, compact member, as it is shown in FIG. 3. The drive motor 12 may further comprise an external power supply connection or a connection to a power supply.

As can be seen from FIG. 3, a shaft coupling 14 is provided between the drive motor 12 and the brake 13, which form the upper end of the drive unit 10 when used, and the threaded spindle 16, which shaft coupling 16 transmits the rotational movement from the output of the drive motor 12 to the threaded spindle 16. The brake 13, the drive motor 12, the shaft coupling 14 and the threaded spindle 16 are provided in this order from top to bottom substantially vertically above each other, when the drive unit 10 is in its built-in position in use. The spindle nut 18 and the slide 20 connected to the spindle nut 18 are movably provided for movement along the threaded spindle 16 and around the threaded spindle.

Upon a rotational movement of the threaded spindle 16, the spindle nut 18 running on the threaded spindle 16 moves linearly along the top-down direction. The spindle nut 18 in turn is fixedly connected to the slide 20, which, accordingly, also moves linearly following the movement of the spindle nut 18. A slide guide 21 is formed in the housing 11 in parallel to the threaded spindle 16, wherein the slide 20 moves along the slide guide 21 upon its linear movement, such that the slide guide 21 stabilizes the movement of the slide 20 thereby which renders the drive unit sturdy. FIG. 3 shows the slide 20 mounted to the spindle nut 18, and the slide guide 21.

Further, FIG. 3 shows a coupling joint 27, which is coupled to the slide 20 such that it is relatively rotatable and can pivot around an axis which runs substantially horizontally when in built-in condition and in use. The coupling joint 27 is formed as a coupling rod. The other end of the coupling rod, which forms the coupling joint 27, is jointly connected to the barrier arm 110 of the safety barrier boom 100, as can be best seen in FIG. 3.

FIG. 3 further shows a pair of helical tension spring assemblies 24, which are provided for supporting the movement of the barrier arms 110, 111 from the closed position of the barrier boom 100 into the open position. For this purpose, the helical tension spring assemblies (which comprise three helical tension springs, respectively, in the embodiment shown) are mounted symmetrically at the slide 20 with their upper ends and are fixedly connected to a bottom plate or the like (not shown) with their lower ends, such that they bias the slide 20 in the direction vertically downwards. Because a movement of the slide 20 from top to bottom corresponds to an opening movement of the barrier arms 110, 111 from the horizontal position into the vertical position during which the effect of gravity on the barrier arms 110, 111 must be overcome, since the barrier arms 110, 111 pivot upwards, the spring assemblies 24 act to support the opening movement and, thus, provide for a balance of the force which has to be applied when opening and when closing the barrier boom 100.

FIG. 3 further shows an emergency release 28 for the drive unit 10. For this purpose, the planetary gear motor 12 is coupled to a brake 13 with manual ventilation. A push rod 22 connects the manual ventilation of the brake 13 to a release device 26. The release device 26 is mounted in the housing 11 of the drive unit 10 and consists of a hexagon bolt and an eccentric washer, such that an excentric connection between the release device 26 and the push rod 22 is established. By rotating the hexagon bolt a linear lifting movement in the direction of the planetary gear motor 12 and the brake 13, respectively, is created, such that the manual ventilation of the brake 13 is actuated. Further, a spring element (release spring element) 30 is provided, which is integrated between the push rod 22 and the manual ventilation of the brake 13 as damping member. This allows to maintain the actuation force over the full lifting movement of the push rod 22 and the design is more fail-safe during assembly.

If an emergency release of the system becomes necessary, e.g. during power failure or defect, or for fulfilling safety requirements, e.g. fire protection requirements, the hexagon bolt can be manually operated from outside and can be released, which actuates the manual ventilation of the brake 13 and which releases the braking torque of the brake 13, such that the barrier arms 110, 111 can be manually lifted or moved down.

When the safety barrier boom 100 according to the embodiment described herein is operated, power is supplied to the drive motor 12, which results in the drive motor 12 generating a rotational force and a torque, which is transmitted into the threaded spindle 16 via the shaft coupling 14 and which makes the threaded spindle 16 rotate. The spindle nut 18 running on the threaded spindle 16 thereby moves linearly either upward (for closing the barrier boom) or downward (for opening the barrier boom) depending on the rotational direction of the threaded spindle 16, because the spindle nut 18 is guided linearly together with slide 20. The spring assemblies 24 support the movement of the slide 20 downwards and additionally draw the slide 20 downwards, such that the force applied for opening the barrier arms 110, 111 in a pivoting movement upwards is increased and, accordingly, the gravitational force acting on the barrier arms 110, 111 against the opening movement is partly compensated for. In the closing direction of the barrier arms 110, 111 the spring assemblies act against the movement direction of the slide 20. Because the gravitational force acts in the direction supporting the closing movement, a similar motor force is sufficient in both movement directions for initiating the barrier arm movement with a compact planetary gear motor.

By means of the coupling rod as a coupling joint 27 the force for opening and closing is transmitted into one of the barrier arms 110 as a push force or a pull force and moves the barrier arms 110, 111 for pivoting upwards or downwards following the downwards or upwards movement the slide 20 because of the rod arrangement between barrier arms 110, 111 and connecting element.

The invention is based on the idea to provide a simple and compact arrangement for a drive unit for a safety barrier boom which still has the necessary sturdiness to the mechanical loads occurring in operation.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A drive unit for a foldable safety barrier boom comprising:
a drive motor;
a threaded spindle which is coupled with the drive motor such that the rotational movement of the output of the drive motor is transmitted to the threaded spindle, and which is coupled with a spindle nut, such that it linearly moves along a slide guide arranged in parallel to the threaded spindle upon rotation of the threaded spindle;
a slide which is fixedly coupled with the spindle nut; and
a coupling joint in the form of a coupling rod, which is jointly provided at the slide for jointly coupling the slide to a barrier arm of the safety barrier boom,
wherein the drive unit further comprises a spring member, which biases the slide in a direction for supporting opening of the safety barrier boom,
wherein the spring element is a pack of biased helical tension springs,
wherein the drive unit further comprises an emergency release comprising a manual ventilation, a push rod and a release device, and
wherein the manual ventilation is coupled with the release device by means of the push rod, a movement at the release device enables a rotation of the drive motor.

2. The drive unit according to claim 1, further comprising a shaft coupling which is provided between the drive motor and the threaded spindle for transmitting the rotational movement of the output of the drive motor to the threaded spindle.

3. The drive unit according to claim 1, wherein the drive motor is a planetary gear motor.

4. The drive unit according to claim 3, wherein the drive motor is a planetary gear motor with a brake.

5. The drive unit according to claim 1, wherein the coupling joint is a coupling rod.
